(19) United States
(12) Patent Application Publication
(10) Pub. No.: US 2007/0224985 A1
(43) Pub. Date: Sep. 27, 2007

(54) Mobile terminal and method for providing location information thereof

(75) Inventor: Joon-Hyuk Choi, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/712,212

(22) Filed: Feb. 28, 2007

(30) Foreign Application Priority Data
Mar. 27, 2006 (KR) 2006-0027282

(51) Int. Cl. H04Q 7/20

(52) U.S. Cl. 455/433

(57) ABSTRACT

A mobile terminal provides the mobile terminal users with convenient identification of a past schedule. The mobile terminal includes a location data receiver, a location information storage unit for storing the mobile terminal's location, a control unit for generating the location information, controlling storage of a reception date and time of the location data and the location information and for detecting location information corresponding to a date in the storage unit, if the date is input to check a past route, and an output unit for outputting the detected location information.

### PRIORITY

This application claims priority under 35 U.S.C. § 119 from Korean Patent Application No. 2006-0027282, which was filed in the Korean Intellectual Property Office on Mar. 27, 2006, the contents of which are incorporated herein by reference.

### BACKGROUND OF THE INVENTION

1. Field of the Invention

The present invention relates to a mobile terminal, and in particular, to a mobile terminal and method for providing a past route thereof corresponding to date/time information stored therein.

2. Description of the Related Art

As a result of development in mobile communication technology and the increasing use of and dependence on mobile terminals, various functions in addition to talk, such as character and image transmission, have been developed. Additionally, many mobile terminals now provide an address book including a personal directory, and a schedule manager. Personal mobility and visiting places are an increasing trend due to business or personal reasons. Accordingly, people frequently must check their mobility information, such as a past route in which they traveled, a place they recently visited and the time of the visit.

Accordingly, an apparatus and a method to provide such past mobility information have been suggested. A mobile communication service company identifies a client's location through a mobile communication network, stores/manages location information, and provides past mobility information to a requester of the information.

However, the conventional apparatus and method have a disadvantage of invading a person's privacy, because the person's past mobility information collected through a separate mobility information management system is provided not only to the person but also to a third party. The conventional apparatus and method is also inconvenient, because since the past mobility information is provided through a communication network, it may not be accessed in poor areas for radio transmission and reception.

### SUMMARY OF THE INVENTION

An object of the present invention is to provide a mobile terminal for individually storing/managing personal past mobility information and providing the information, and a method thereof.

Another object of the present invention is to provide a mobile terminal for storing location information by time and providing the information, and a method thereof.

In order to accomplish the above objects, a mobile terminal according to the present invention includes a location data receiver for receiving location data of the mobile terminal, a location information storage unit for storing location information of the mobile terminal, calculated from the location data received through the location information receiver, by date/time, a control unit for generating the location information by using the received location data, for controlling the storing of a reception date/time of the location data and the location information in the location information storage unit, and for detecting location information in the location information storage unit corresponding to a date, if the date is input to check a past route, and an output unit for outputting the detected location information.

The location data receiver preferably receives location data from a base station of a local area in which the mobile terminal is located.

The location data receiver is preferably configured as a GPS receiver.

The control unit preferably stores a calculation interval of current location information, activates the GPS receiver at the calculation intervals of current location information, and generates the current location information by using GPS data received through the GPS receiver.

The control unit preferably compares the current location information with previously stored location information, and controls the storage of the current location information in the location information storage unit, if the current location is displaced more than a selected distance from the previously stored location.

The control unit preferably generates current location information from GPS data, compares the current location information with previously stored location information, and stores the current location information in the location information storage unit, if the current location is displaced more than a selected distance from the previously stored location.

The control unit preferably detects location information in the location information storage unit corresponding to a date/time, if the date/time is input to check a past route of the mobile terminal.

The location information storage unit preferably includes a time information field for storing a reception date/time of the location information, a location coordinate field for storing location coordinates, and a regional information field for storing regional information corresponding to the location coordinates.

The output unit preferably displays the location information in text form.

Preferably, the mobile terminal further includes a map information storage unit for storing map information, wherein the control unit searches the map information storage unit corresponding to the location information by date/time detected in the location information storage unit, detects the corresponding map information, and controls the output unit to display the location information on a map.

A method for providing location information by utilizing a mobile terminal according to the present invention includes calculating a location of a mobile terminal and storing the location information and time information in the mobile terminal, searching the location information corresponding to a request for location information for a specific date, and providing the search result.

The calculating step further includes receiving location data from a base station of an area in which the mobile terminal is located, generating location information by using the location data, and storing reception date/time of the location data and the location information.

The calculating step also further includes receiving GPS data from GPS satellites, generating current location information of the mobile terminal by using the GPS data, and storing reception date/time of the GPS data and the current location information.

The GPS data is received at calculation intervals of current location information.

In the step of storing current location information, the current location information is compared with previously stored location information, and is stored if the current location is displaced more than a selected distance from the previously stored location. The provided searched result is displayed in text form, and map information stored in the mobile terminal is searched corresponding to the result of the searching step, the corresponding map information is detected, and the location information is displayed on a map.

### BRIEF DESCRIPTION OF THE DRAWINGS

The above and other objects, features and advantages of the present invention will become more apparent from the following detailed description in conjunction with the accompanying drawings, in which:

FIGS. 1A and 1B are block diagrams of a mobile terminal according to first and second embodiments, respectively, of the present invention;

FIG. 2 is a view of a database structure for managing location information in the mobile terminal according to the present invention;

FIG. 3 is a flow chart showing a method of providing location information of the mobile terminal according to the present invention;

FIGS. 4A and 4B are flow charts showing detailed steps of the storing location information method illustrated in FIG. 3; and

FIGS. 5A to 5F are screens shown in providing location information of the mobile terminal according to the present invention.

### DETAILED DESCRIPTION OF EXEMPLARY EMBODIMENTS OF THE INVENTION

Hereinafter, preferred embodiments of the present invention are described in detail with reference to the accompanying drawings. The same reference numbers are used for the same or like components in the accompanying drawings. Additionally, detailed explanations for well-known functions and compositions are omitted for the sake of clarity and conciseness.

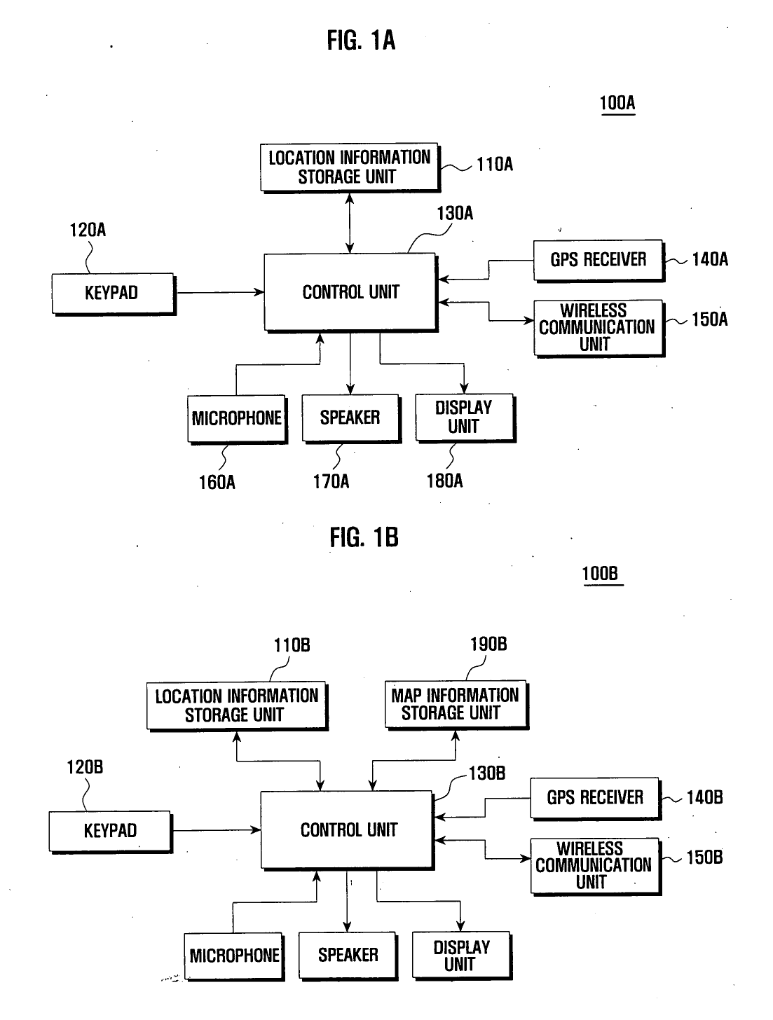

FIG. 1A shows a mobile terminal displaying location information in text form, and FIG. 1B shows a mobile terminal displaying location information on a pre-stored map.

Referring to FIG. 1A, a mobile terminal 100A according to a first embodiment of the present invention includes a location information storage unit 110A, keypad 120A, control unit 130A, GPS receiver 140A, wireless communication unit 150A, microphone 160A, speaker 170A and display unit 180A.

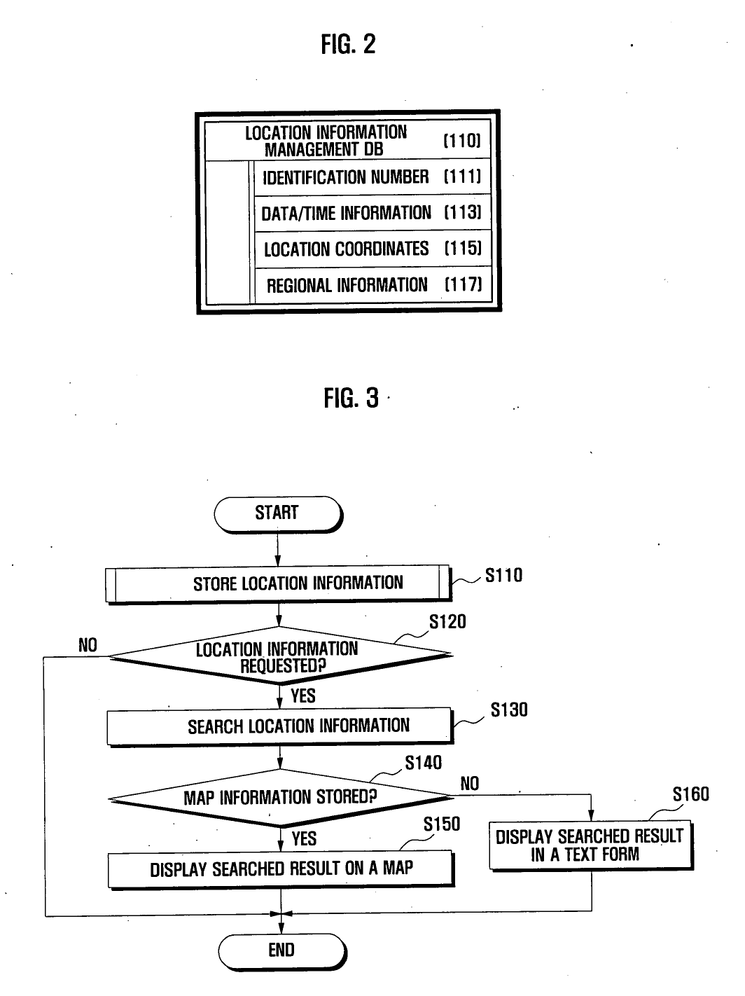

The location information storage unit 100A stores location information (hereinafter, the location information includes regional information) of the mobile terminal 100A by date/time. The location information is calculated from GPS data received through the GPS receiver 140A, and an example of storing the location information is shown in FIG. 2. An example of a field configuration of location information management database for storing the location information will be described below with reference to FIG. 2.

The keypad 120A provides a user interface for controlling the operation of the mobile terminal 100A. The keypad 120A receives the user's signal to check location information, and transmits it to the control unit 130A. For example, the keypad 120A receives the user's selection information on date/time to check a past route, and transmits it to the control unit 130A.

The control unit 130A controls the mobile terminal 100A by signals input through the keypad 120A or pre-stored operation programs. For example, if time information (date/time) is input to check a past route through the keypad 120A, the control unit 130A detects location information in the location information storage unit 100A corresponding to the time information, and provides it to the user.

The control unit 130A preferably generates the location information as video or audio data. That is, the control unit 130A generates the location information as video data, and outputs the video data (for example, a text) through the display unit 180A. Alternatively, the control unit 130A generates the location information as audio data, and outputs the audio data through the speaker 170A.

The control unit 130A receives GPS data through the GPS receiver 140A, generates current location information of the mobile terminal 100a by using the GPS data, and controls storage of reception date/time of the GPS data and the location information in the location information storage unit 100A. For this, the control unit 130A preferably activates the GPS receiver 140A at calculation intervals of current location information, and generates the current location information by using the received GPS data. Alternatively, the control unit 130A may receive the GPS data continuously through the GPS receiver 140A, and generate the current location information at the calculation intervals of current location information by using the GPS data. The calculation interval may be a value preset by a user.

The control unit 130A stores the calculated current location information at the calculation intervals or only when the current location is displaced more than a selected distance from the previously stored location.

In order to prevent past route information stored in the location information storage unit 100A from being accessed by an unauthorized user, the control unit 130A can delete or modify the contents of the location information storage unit 100A corresponding to a request from an authorized user. The authorized user, when inputting time information to check a past route, preferably performs an additional step such as identifying a password, to identify whether the user is an authorized user.

The GPS receiver 140A is controlled by the control unit 130A, and transmits GPS data to the control unit 130A.

The wireless communication unit 150A provides a communication interface through a wireless communication network, and controls data communication through the wireless communication network.

The microphone 160A and the speaker 170A operate under the control of the control unit 130A. The microphone 160A collects audio signals, such as voice signals, and transmits them to the control unit 130A. The speaker 170A outputs audio signals transmitted by the control unit 130A. The speaker 170A preferably receives audio mobility information generated by a user's request from the control unit 130A, and outputs the information.

The display unit 180A outputs video signals under the control of the control unit 130A. For example, the display unit 180A receives video mobility information generated by the user's request from the control unit 130A, and displays the information.

Referring to FIG. 1B, a mobile terminal 100B according to a second embodiment of the present invention includes a location information storage unit 110B, keypad 120B, control unit 130B, GPS receiver 140B, wireless communication unit 150B, microphone 160B, speaker 170B, display unit 180B, and map information storage unit 190B. The location information storage unit 110B stores location information of the mobile terminal 100B by date/time. The location information is calculated from GPS data received through the GPS receiver 140B, and an example of the location information is shown in FIG. 2. An example of a field configuration of a location information management database for storing the location information will be described below with reference to FIG. 2.

The keypad 120B provides a user's interface controlling the operation of the mobile terminal 100B. The keypad 120B receives the user's signal to check location information, and transmits it to the control unit 130B. For example, the keypad 120B receives the user's selection information on date/time to check a past route, and transmits it to the control unit 130B.

The control unit 130B controls the mobile terminal 100B by signals input through the keypad 120B or pre-stored operation programs. For example, if time information (time/date) is input to check a past route through the keypad 120B, the control unit 130B detects location information in the location information storage unit 110B corresponding to the time information, and provides it to the user.

The control unit 130B preferably generates the location information as video or audio data. That is, the control unit 130A generates the location information as video data, and outputs the video data (for example, a text) through the display unit 180B. Alternatively, the control unit 130B generates the location information as audio data, and outputs the audio data through the speaker 170B.

Preferably, the control unit 130B searches the map information storage unit 190B corresponding to the location information, detects the corresponding map information, and controls the display unit 180B to display the location information on a map.

The control unit 130B receives GPS data through the GPS receiver 140B, generates current location information of the mobile terminal 100B by using the GPS data, and controls storage of reception date/time of the GPS data and the location information in the location information storage unit 110B. For this, the control unit 130B preferably activates the GPS receiver 140B at calculation intervals of current location information, and generates the current location information by using the received GPS data. Alternatively, the control unit 130B may receive the GPS data continuously through the GPS receiver 140B, and generate the current location information at the calculation intervals by using the GPS data. The calculation interval is a value that can be preset by a user's selection information.

The control unit 130B controls storage of the calculated current location information at the calculation intervals of current location information or only when the current location is displaced more than a selected distance from the previously stored location.

In order to prevent past route information stored in the location information storage unit 110B from being accessed by an unauthorized user, the control unit 130B is provided to delete or modify the contents of the location information storage unit 110B corresponding to a request from an authorized user. The authorized user, when inputting time information to check a past route, preferably performs an additional step such as identifying a password, to identify whether the user is an authorized user.

The GPS receiver 140B is controlled by the control unit 130B, and transmits GPS data received from GPS satellites to the control unit 130B.

The wireless communication unit 150B provides a communication interface through a wireless communication network, through which it controls data communication.

The microphone 160B and the speaker 170B operate under the control of the control unit 130B. The microphone 160B collects audio signals, such as voice signals, and transmits them to the control unit 130B. The speaker 170A outputs audio signals transmitted by the control unit 130B. The speaker 170B preferably receives audio mobility information generated by a user's request from the control unit 130B, and outputs the information.

The display unit 180B outputs video signals under the control of the control unit 130B. For example, the display unit 180B receives video mobility information generated by the user's request from the control unit 130B, and displays the information. Additionally, the display unit 180B receives location information indicated on a map, and displays the information.

In FIGS. 1A and 1B, the mobile terminals 100A and 100B include, respectively, GPS receivers 140A and 140B, and calculate/store the current locations of the mobile terminals 100A and 100B by using GPS data received through the GPS receivers 140A and 140B. However, the present invention is not limited to calculating the current locations of the mobile terminals 100A and 100B by using the GPS data. The present invention may also utilize location information received from a base station. In this case, GPS receivers 140A and 140B may be substituted by a location information receiver, or location information of the mobile terminals 100A and 100B is received from a base station through wireless communication units 150A and 150B.

FIG. 2 is a view showing an example of a database structure to manage location information in the mobile terminal, and to store location information of the mobile terminals 100A and 100B, respectively, in the location information storage unit 110A shown in FIG. 1A and location information storage unit 110B shown in FIG. 1B.

Referring to FIG. 2, the location information management database 110 includes an identification number field 111, date/time information field 113, location coordinate field 115 and regional information field 117.

The identification number field 111 stores information to identify the corresponding location information.

The date/time information field 113 stores date/time information on the corresponding location information collected. That is, the date/time information field 113 stores date/time information on which the mobile terminal was located at the corresponding location.

The location coordinate field 115 stores the coordinates (i.e. x-coordinate and y-coordinate) of the corresponding location.

The regional information field 117 stores regional information (e.g., a name of a building or a road) corresponding to the location coordinates.

FIG. 3 is a flow chart showing a method of providing location information of the mobile terminal according to the present invention. Referring to FIG. 3, the mobile terminal stores location information in step S110. The mobile terminal includes a GPS receiver, and stores location information calculated from GPS data received through the GPS receiver by reception date/time of the GPS data.

In step S130, if location information has been requested in step S120, namely, if a user requests the location information by designating specific date/time in the past, the mobile terminal searches location information stored in step S110. That is, location information corresponding to the specific date/time is detected from the location information stored in step S110.

Subsequently, the location information is provided to the user. At this moment, the mobile terminal checks whether map information is internally stored in step S140, and displays the location information on a map in step S150, if the map information is stored. When the map information is not stored, the mobile terminal displays the search result of the location information in text form in step S160.

This method further includes deleting or modifying the contents of the location information corresponding to an authorized user's request, so that past route information stored in the location information storage unit 100A cannot be accessed by an unauthorized user. An additional step is preferably performed to identify whether the time information is input by the authorized user when time information is input to check a past route in step S130. A function of locking the location information is preferably performed.

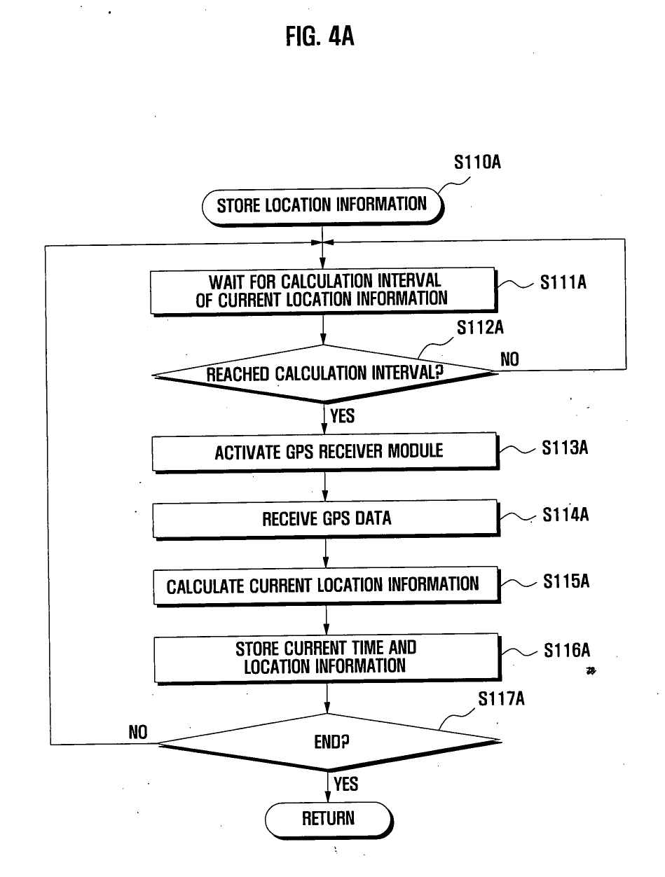

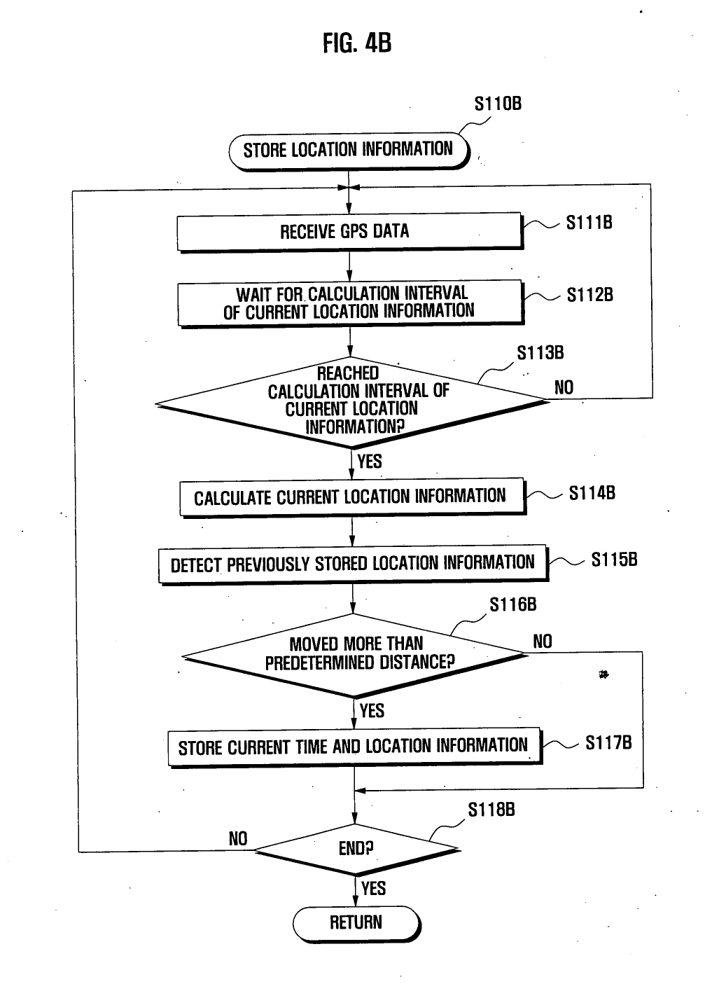

FIG. 4A shows a GPS receiver module of a mobile terminal that periodically activates and calculates/stores current location from received GPS data. FIG. 4B shows a mobile terminal that continuously receives the GPS data and stores the current location information when the mobile terminal is displaced out of a range.

Referring to FIG. 4A, the mobile terminal stores a calculation interval of current location information and waits for the calculation interval while counting down the time in step S111A. At this moment, the GPS module is not in an operation mode. The calculation interval of the current location information uses a value that can be preset by a user's selection information.

If an interval of the current location information is passed in step S112A, the mobile terminal activates the GPS receiver module in step S113A, and receives GPS data in step S114A. Subsequently, the mobile terminal calculates current location information by using the GPS data in step S115A, and stores the current time and location information in step S116A. At this moment, the current time is stored as a reception time of the GPS data.

Until a request for ending is input in step S117A, the above steps S111A to S116A are performed repeatedly.

Referring to FIG. 4B, the mobile terminal continuously receives GPS data from GPS satellites in step S111B while waiting for a calculation interval of current location information in step S112B. That is, the mobile terminal stores the calculation interval of the current location information and counts down the time while waiting for a calculation interval of the current location information. If the calculation interval of the current location information is reached in step S113B, the mobile terminal calculates current location information by using the GPS data in step S114B, and detects previously stored location information in step S115B. In step S115B, the mobile terminal may pre-store the previously stored location information or only the GPS data received during the previous interval, and calculate previously stored location information by using the GPS data. The calculation interval of the current location information uses a value that can be preset by a user's selection information.

In step S116B, the mobile terminal compares the previously stored location information detected in step S115B with the current location information calculated in step S114B. That is, the mobile terminal identifies the distance between the previously stored location and the current location, and identifies whether the mobile terminal has moved out of a range.

The mobile terminal stores the current location information in step S117B only when the mobile terminal has moved out of the range. The mobile terminal preferably stores the current time as a reception time of GPS data that is the calculation base of the current location information.

Until a request for ending is input in step S118B, the above steps S111B to S117B are performed repeatedly.

FIGS. 4A and 4B show examples of storing location information at time intervals or only when the location is displaced more than a selected distance. However, the present invention is not limited to FIGS. 4A and 4B. For example, the methods illustrated in FIGS. 4A and 4B maybe combined. That is, after calculating the current location information at time intervals, the current location information may be stored only when the current location is displaced more than a selected distance from the previously stored location.

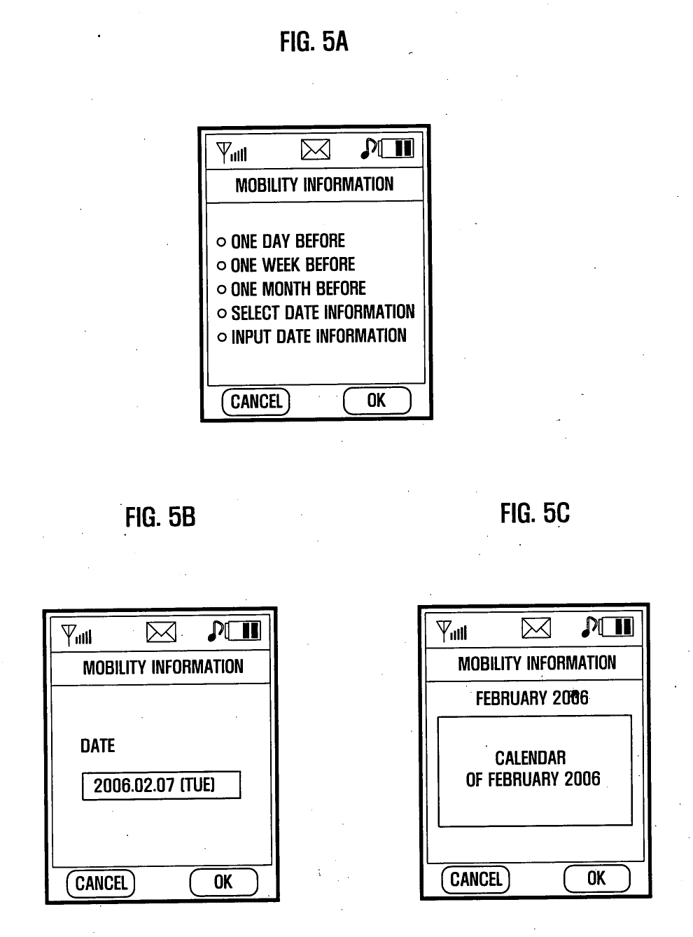

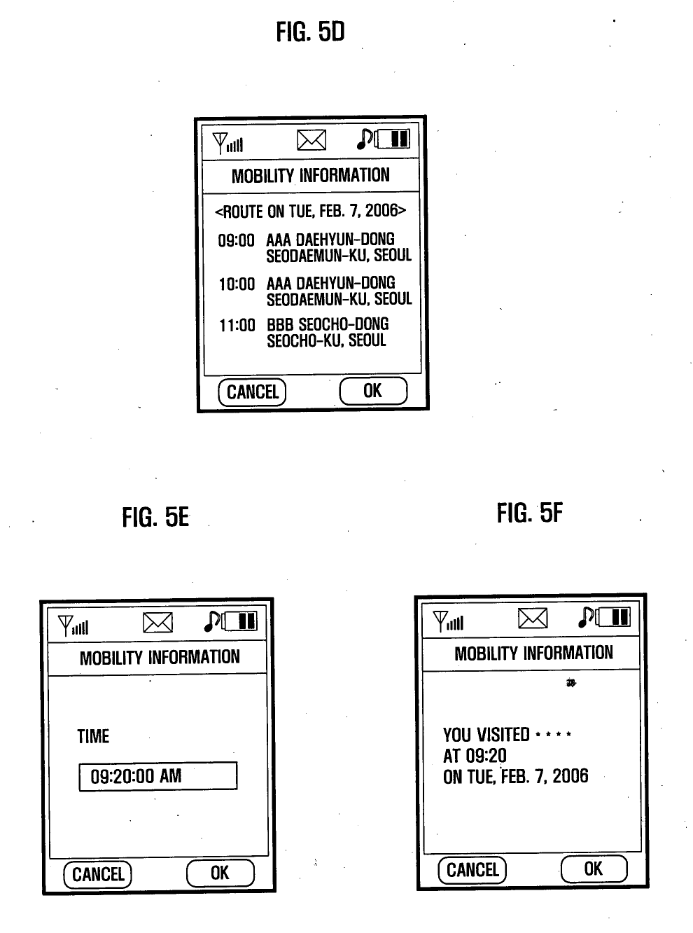

FIG. 5A shows an initial screen when the mobile terminal operates in a past mobility information identification mode. Accordingly, a user may select past time information to check the mobility information by selecting from the options of a ‘One day before’, ‘One week before’, or ‘One month before’, based on the current date/time. A ‘date information selection’ option can be selected with a desired date from a calendar displayed correspondingly, or a ‘date information input’ option can be selected along with direct input of a desired date.

FIG. 5B shows ‘date information input’ is selected in FIG. 5A and input of a desired date (e.g., Tuesday, Feb. 7, 2006). FIG. 5C shows a screen in which ‘date information selection’ is selected in FIG. 5A and a calendar (e.g., a calendar of February 2006) is displayed for the user to select a date.

FIG. 5D shows a route displayed by time when the corresponding past date has been selected to check mobility information through any screen of FIGS. 5A, 5B, or 5C. FIG. 5D shows a display of route information stored at 1-hour intervals. That is, FIG. 5D shows an example in which route information is displayed corresponding to a specific past date in a text form. However, the present invention may alternatively provide a method of displaying the location information on a map.

FIG. 5E shows an input of time information when the past date has been selected to check mobility information through any screen of FIGS. 5A, 5B, or 5C. Although FIG. 5E shows a direct input of the time information, the input method of the time information is not limited to the direct input method. For example, time information to check mobility information, such as hour, minute and second may be input by a menu selection method. FIG. 5E shows ‘AM 09:20:00’ input as time information to check mobility information.

FIG. 5F shows pre-storage of location information corresponding to the selected date/time information. That is, FIG. 5F shows an example of displaying a visited location at 9:20 AM, Tuesday, Feb. 7, 2006, or regional information. Although FIG. 5F shows location information displayed in text form, the present invention may alternatively provide a method of displaying the location information on a map.

As described above, the present invention provides individual past mobility information such that personal privacy is not invaded by storing location information of a mobile terminal by date/time. Additionally, the individual past mobility information may be provided regardless of a communication state. Accordingly, users may conveniently check his/her past schedules.

Although example embodiments of the present invention have been described in detail herein above, it should be understood that many variations and/or modifications of the basic inventive concept herein described, which may appear to those skilled in the art, will still fall within the spirit and scope of the example embodiments of the present invention as defined in the appended claims.

What is claimed is:

1. A mobile terminal, comprising:
a location data receiver for receiving location data of the mobile terminal;
a location information storage unit for storing, by date/time, location information of the mobile terminal, calculated from the received location data;
a control unit for generating the location information by using the received location data, controlling storage of a reception date/time of the location data and the location information in the location information storage unit, and detecting location information corresponding to a date in the location information storage unit, if the date is input to check a past route; and
an output unit for outputting the detected location information.

2. The mobile terminal of claim 1, wherein the location data receiver receives location data from a base station of a local area in which the mobile terminal is located.

3. The mobile terminal of claim 1, wherein the location data receiver is a GPS receiver.

4. The mobile terminal of claim 3, wherein the control unit stores a calculation interval of current location information, activates the GPS receiver at the calculation intervals, and generates the current location information by using GPS data received through the GPS receiver.

5. The mobile terminal of claim 4, wherein the control unit compares the current location information with previously stored location information, and controls storage of the current location information in the location information storage unit, if the current location is displaced more than a selected distance from the previously stored location.

6. The mobile terminal of claim 3, wherein the control unit generates current location information from GPS data received through the GPS receiver, compares the current location information with previously stored location information, and controls storage of the current location information in the location information storage unit, if the current location is displaced more than a selected distance from the previously stored location.

7. The mobile terminal of claim 1, wherein the control unit detects location information corresponding to a date and time in the location information storage unit, if the date and time are input to check a past route of the mobile terminal.

8. The mobile terminal of claim 1, wherein the control unit deletes or modifies the contents of the location information storage unit corresponding to a user's request so that the location information stored in the location information storage unit is inaccessible by an unauthorized user.

9. The mobile terminal of claim 1, wherein the control unit locks the location information storage unit, so that the location information stored in the location information storage unit is inaccessible by an unauthorized user.

10. The mobile terminal of claim 1, wherein the location information storage unit includes:
a time information field for storing a reception date and time of the location information;
a location coordinate field for storing location coordinates; and
a regional information field for storing regional information corresponding to the location coordinates.

11. The mobile terminal of claim 1, wherein the output unit displays the location information in text form.

12. The mobile terminal of claim 1, further comprising a map information storage unit for storing map information, wherein the control unit searches the map information storage unit corresponding to the location information by date and time detected in the location information storage unit, detects the corresponding map information, and controls the output unit to display the location information on a map.

13. A method for providing location information by utilizing a mobile terminal, comprising:
calculating a location of a mobile terminal and storing the location information and time information in the mobile terminal;
searching the location information corresponding to a request for location information for a specific date; and
providing the search result.

14. The method of claim 13, further comprising deleting or modifying the contents of the location information corresponding to an authorized user's request so that the stored location information is inaccessible by an unauthorized user.

15. The method of claim 13, wherein, in the searching step, location information is searched corresponding to a specific date and time, if the location information by date and time is requested.

16. The method of claim 13, wherein the searching step further includes identifying whether a user is authorized, corresponding to a request for location information by date and time.

17. The method of claim 13, wherein the calculating step includes:
receiving location data from a base station of an area in which the mobile terminal is located;
generating location information by using the location data; and
storing reception date and time of the location data and the location information.

18. The method of claim 13, wherein the calculating step includes:
receiving GPS data from GPS satellites;
generating current location information of the mobile terminal by using the GPS data; and
storing reception date and time of the GPS data and the current location information.

19. The method of claim 18, wherein, in the step of receiving GPS data, the GPS data is received at intervals of current location information.

20. The method of claim 18, wherein, in the step of storing current location information, the current location information is compared with previously stored location information, and is stored if the current location is displaced more than a selected distance from the previously stored location.

21. The method of claim 13, wherein, in the providing step, the searched result is displayed in text form.

22. The method of claim 13, wherein, in the providing step, map information stored in the mobile terminal is searched corresponding to the result of the searching step, the corresponding map information is detected, and the location information is displayed on a map.
